(19) United States
(12) Patent Application Publication
(10) Pub. No.: US 2024/0424943 A1
(43) Pub. Date: Dec. 26, 2024

(54) CHARGING TO AND FROM A VEHICLE BATTERY SYSTEM VIA A MULTI-PORT CHARGING SYSTEM

(71) Applicant: GM Global Technology Operations LLC, Detroit, MI (US)

(72) Inventors: Rashmi Prasad, Troy, MI (US); Chandra S. Namuduri, Troy, MI (US)

(21) Appl. No.: 18/339,418

(22) Filed: Jun. 22, 2023

(51) Int. Cl. B60L 55/00; B60L 53/16; B60L 53/20; H02J 3/32; H02J 7/00

(52) U.S. Cl. CPC B60L 55/00; B60L 53/16; B60L 53/20; H02J 3/322; H02J 7/0063; B60L 2210/10; B60L 2210/30; H02J 2310/48

(57) ABSTRACT

A charging system of a vehicle includes a first charge port selectively connectable to a battery system of the vehicle, the first charge port configured to receive electrical power from a power source to charge the battery system, and a second charge port selectively connectable to the battery system of the vehicle, the second charge port connected to a bi-directional charger. The charging system also includes a controller configured to connect the battery system to the first charge port and control a first charging operation to charge the battery system, connect the battery system to the second charge port, and control a second charging operation to supply electrical power to charge an external energy storage system.

### INTRODUCTION

The subject disclosure relates to batteries and battery assemblies, and more particularly to systems and methods for supplying power from a vehicle battery system to another vehicle battery or other external energy storage system.

Vehicles, including gasoline and diesel power vehicles, as well as electric and hybrid electric vehicles, feature battery storage for purposes such as powering electric motors, electronics and other vehicle subsystems. Battery assemblies may be charged using dedicated charging stations and other power sources such as residences and buildings connected to a power grid. In addition, some vehicles may have the capability to transfer power to external locations, such as by supplying power to battery assemblies of other vehicles and/or to a grid. Such capabilities are useful, for example, in situations in which an electric vehicle is running low on charge and a charging station or other power source is unavailable.

### SUMMARY

In one exemplary embodiment, a charging system of a vehicle includes a first charge port selectively connectable to a battery system of the vehicle, the first charge port configured to receive electrical power from a power source to charge the battery system, and a second charge port selectively connectable to the battery system of the vehicle, the second charge port connected to a bi-directional charger. The charging system also includes a controller configured to connect the battery system to the first charge port and control a first charging operation to charge the battery system, connect the battery system to the second charge port, and control a second charging operation to supply electrical power to charge an external energy storage system.

In addition to one or more of the features described herein, the external energy storage system is a recipient vehicle connected to the second charge port by a charging cable.

In addition to one or more of the features described herein, the power source is selected from a charging station, an electrical grid and another vehicle.

In addition to one or more of the features described herein, the second charging operation is performed simultaneously with the first charging operation.

In addition to one or more of the features described herein, the battery system includes a first battery pack and a second battery pack connected in parallel to a vehicle propulsion system, the first charge port is selectively connectable to the first battery pack, and the second charge port is selectively connectable to the second battery pack.

In addition to one or more of the features described herein, the controller is configured to control the first charge port to charge the first battery pack with the electrical power from the power source, and control the second charge port and the bi-directional charger to charge the external energy storage system.

In addition to one or more of the features described herein, the controller is configured to communicate with a recipient controller of the external energy storage system, the recipient controller configured to provide charging parameters for the second charging operation.

In addition to one or more of the features described herein, the controller is configured to acquire pricing information related to the power source, and perform at least one of monitoring the second charging operation, controlling the second charging operation based on the pricing information, and providing the pricing information to a recipient controller of the external energy storage system.

In addition to one or more of the features described herein, the power source is a donor battery system of a donor vehicle, the external energy storage system is a recipient vehicle, and the controller is configured to perform at least one of controlling the first charge port to charge the battery system and controlling the second charge port to simultaneously charge the recipient vehicle, and controlling the first charge port to receive a charging current from the donor battery system, and controlling one or more switches connected to the battery system to bypass the battery system and transfer the charging current to the recipient vehicle.

In another exemplary embodiment, a method of transferring charge includes connecting a power source to a first charge port, and electrically coupling the first charge port to a battery system of the vehicle, the first charge port configured to receive electrical power from the power source to charge a battery system, and connecting an external energy storage system to a second charge port, and electrically coupling the second charge port to the battery system, the second charge port connected to a bi-directional charger. The method also includes performing a first charging operation to charge the battery system, and performing a second charging operation to supply electrical power to charge the external energy storage system.

In addition to one or more of the features described herein, the external energy storage system is a recipient vehicle connected to the second charge port by a charging cable, and the power source is selected from a charging station, an electrical grid and another vehicle.

In addition to one or more of the features described herein, the second charging operation is performed simultaneously with the first charging operation.

In addition to one or more of the features described herein, the battery system includes a first battery pack and a second battery pack connected in parallel to a vehicle propulsion system, the first charge port is selectively connectable to the first battery pack, and the second charge port is selectively connectable to the second battery pack.

In addition to one or more of the features described herein, performing the first charging operation includes controlling the first charge port to charge the first battery pack with the electrical power from the power source, and performing the second charging operation includes controlling the second charge port and the bi-directional charger to charge the external energy storage system.

In addition to one or more of the features described herein, the method further includes communicating with a recipient controller of the external energy storage system to determine charging parameters for the second charging operation.

In addition to one or more of the features described herein, the communicating includes acquiring pricing information related to the power source, and performing at least one of: monitoring the second charging operation, controlling the second charging operation based on the pricing information, and providing the pricing information to a recipient controller of the external energy storage system.

In yet another exemplary embodiment, a vehicle system includes a battery system and a charging system connected to the battery system, the charging system including a controller configured to perform a method. The method includes connecting a power source to a first charge port, and electrically coupling the first charge port to the battery system, the first charge port configured to receive electrical power from the power source to charge the battery system, and connecting an external energy storage system to a second charge port, and electrically coupling the second charge port to the battery system, the second charge port connected to a bi-directional charger. The method also includes performing a first charging operation to charge the battery system, and performing a second charging operation to supply electrical power to charge the external energy storage system.

In addition to one or more of the features described herein, the second charging operation is performed simultaneously with the first charging operation.

In addition to one or more of the features described herein, the battery system includes a first battery pack and a second battery pack connected in parallel to a vehicle propulsion system, the first charge port is selectively connectable to the first battery pack, and the second charge port is selectively connectable to the second battery pack.

In addition to one or more of the features described herein, the controller is configured to control the first charge port to charge the first battery pack with the electrical power from the power source, and control the second charge port and the bi-directional charger to charge the external energy storage system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top schematic view of a motor vehicle including a battery system and a charging system, in accordance with an exemplary embodiment;

FIG. 2 depicts an example of a bidirectional charging device or charger;

FIG. 3 is a circuit diagram depicting an embodiment of a vehicle charging system, in accordance with an exemplary embodiment;

FIG. 4 schematically depicts aspects of an electric vehicle including a charging system, the charging system connected to a recipient vehicle, in accordance with an exemplary embodiment;

FIG. 5 depicts a plurality of vehicles in a daisy chain charging configuration, in accordance with an exemplary embodiment;

FIG. 6 is a flow diagram depicting aspects of a method of charging a vehicle battery system and/or an external energy storage system, in accordance with an exemplary embodiment; and

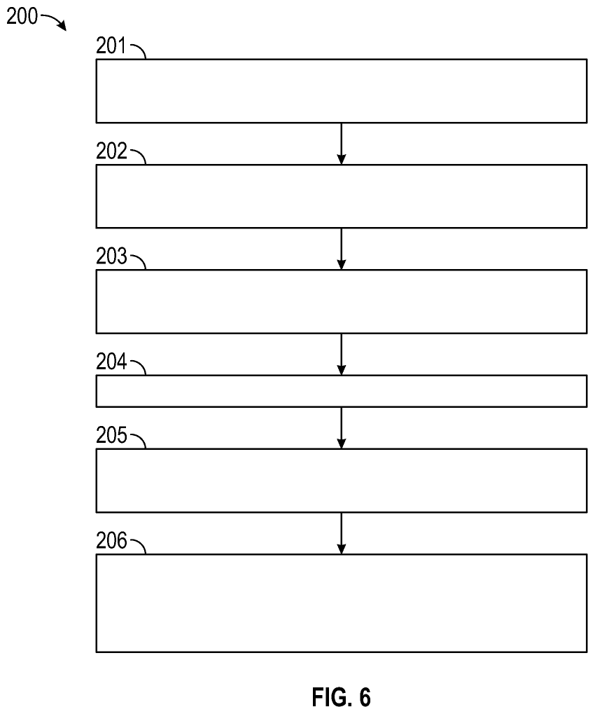

FIG. 7 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for transferring charge or energy from a battery assembly of a vehicle (a donor vehicle) to an external energy storage system (e.g., another vehicle or a power grid). In an embodiment, the external energy storage system is a battery of another vehicle (a recipient vehicle). An embodiment of a vehicle charging system is a multi-port charging system having at least two charge ports.

In an embodiment, the charging system includes a first charge port that is selectively connectable to a vehicle battery system for charging the battery system by a power source (e.g., a charging station or other vehicle battery). The first charge port may be connected to a bi-directional charger or configured for uni-directional charging (e.g., direct current (DC) fast charging (DCFC)).

A second charge port is connected to a bi-directional charger so that the battery system can be used to discharge electrical power and charge an external energy storage system, such as a battery system of a recipient vehicle. The second charge port can be utilized when the battery system is being charged (e.g., during a first charging operation) via the first charge port, so that the vehicle battery system and the recipient vehicle can be charged simultaneously.

Embodiments described herein present numerous advantages and technical effects. For example, the embodiments provide additional resources and opportunities for providing charging capability, which can be beneficial in terms of efficiency and time, and also address situations where charging stations are limited. For example, the embodiments can be used to simultaneously charge multiple vehicles from a single power source, allowing multiple vehicles (e.g., fleet vehicles) to be charged even with limited power source availability.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

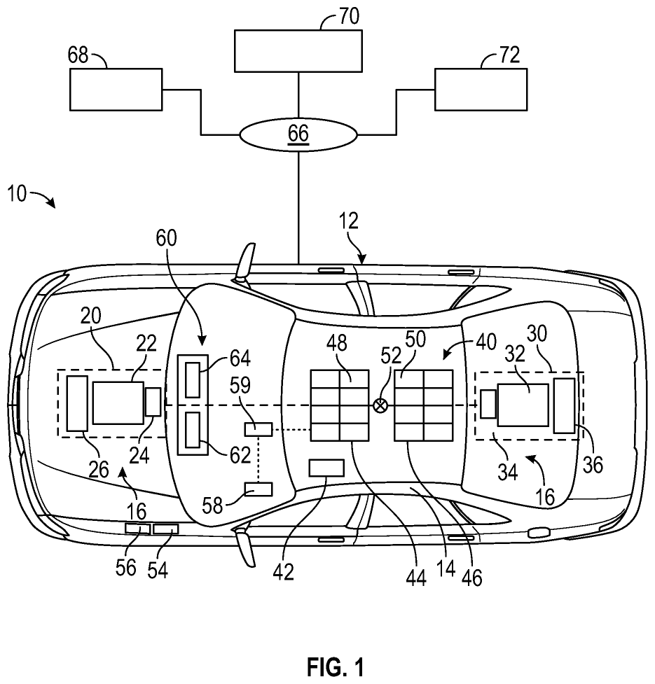

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be an electrically powered vehicle (EV), a hybrid vehicle or any other vehicle. In an embodiment, the vehicle 10 is an electric vehicle, which includes one or more motors and one or more drive systems. For example, the propulsion system 16 is a multi-drive system that includes a first drive unit 20 and a second drive unit 30. The first drive unit 20 includes a first electric motor 22 and a first inverter 24, as well as other components such as a cooling system 26. The second drive unit 30 includes a second electric motor 32 and a second inverter 34, and other components such as a cooling system 36. The inverters 24 and 34 (e.g., traction power inverter units or TPIMs) each convert DC power from a high voltage (HV) battery system 40 to poly-phase (e.g., two-phase, three-phase, six-phase, etc.) alternating current (AC) power to drive the motors 22 and 32.

As also shown in FIG. 1, the drive systems are configured such that the first electric motor 22 drives front wheels (not shown) and the second electric motor 32 drives rear wheels (not shown). However, embodiments are not so limited, as there may be any number of drive systems and/or motors at various locations (e.g., a motor driving each wheel, twin motors per axle, etc.). For example, the vehicle 10 may have a single drive unit.

In the propulsion system 16, the drive unit 20 and the drive unit 30 are electrically connected to the battery system 40. The battery system 40 may also be electrically connected to other components, such as vehicle electronics (e.g., via an auxiliary power module or APM 42). The battery system 40 may be configured as a rechargeable energy storage system (RESS).

The battery system 40 includes one or more battery assemblies. For example, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the inverter 24, and a second battery pack 46 connected to the inverter 34. The battery pack 44 includes a plurality of battery modules 48, and the battery pack 46 includes a plurality of battery modules 50. Each module 48, 50 includes a number of individual cells (not shown).

The battery system 40 can be configured to provide different output voltage levels. For example, a battery switching device 52 is included for selectively connecting the battery pack 44 to the battery pack 46 in series to provide a relatively high voltage (e.g., 800V). The battery switching device 52 can also be operated to connect the battery packs in parallel to provide a relatively low voltage (e.g., 400 V).

The vehicle 10 also includes a charging system, which can be used to charge the battery system 40 and/or to supply power from the battery system 40 to charge another energy storage system (e.g., vehicle-to-vehicle (V2V) and/or vehicle-to-everything (V2X) charging). The charging system includes one or more conversion devices for controlling aspects of charging and/or discharging. For example, at least one conversion device provides for conversion between AC current and DC current and/or voltage control. The conversion device may be a bi-directional conversion device that allows a charge port to be used for either charging or discharging.

In an embodiment, the charging system is a multi-port charge system having at least two charge ports 54 and 56. Each charge port 54, 56 is connected to one of the battery packs. For example, the charge port 54 is selectively connectable to the battery pack 44, and the charge port 56 is selectively connectable to the battery pack 46. Each battery pack can thus be separately charged, simultaneously if desired.

It is noted that the vehicle 10 is not limited to two charge ports. The vehicle 10 may include any number of charge ports and any number of battery packs.

In addition, one or more of the charge ports is connected to a respective battery pack via a conversion device. For example, the charging system includes a conversion device 58 connected to the charge port 54 for converting AC current (e.g., from an electrical outlet or grid) to DC current, and for controlling DC current voltage. In this way, the conversion device 58 can accept charge from various power sources, including AC power sources and DC sources such as traditional charging stations and DC fast charging (DCFC) stations.

In an embodiment, the charging system is configured to both receive charge to charge the battery system 40 and to supply charge to external power storage systems. For example, the conversion device 58 is a bi-directional charger that permits both charging the battery system 40 and discharging the battery system 40 to supply charge to an external power storage device, such as the battery system of another vehicle (V2V charging).

The charging system includes at least one processor or processing device for controlling aspects of charging operations described herein, referred to as a controller 59. The controller 59 may be an onboard charging module (OBCM) or a battery management system (BMS) controller, or a combination thereof. It is noted that embodiments are not limited to any specific controller or processing device, and may encompass multiple processors or control devices.

The vehicle 10 also includes a computer system 60 that includes one or more processing devices 62 and a user interface 64. The computer system 60 may communicate with the charging system controller, for example, to provide commands thereto in response to a user input. The various processing devices, modules and units may communicate with one another via a communication device or system, such as a controller area network (CAN) or transmission control protocol (TCP) bus.

In addition, the charging system, the controller 59, the computer system 60 and/or other processing components in the vehicle 10 may be configured to communicate with various remote devices and systems such as charge stations and other vehicles. Such communication can be realized, for example, via a network 66 (e.g., cellular network, cloud, etc.) and/or via wireless communication. For example, the vehicle 10 may communicate with one or more charging stations 68, a remote entity 70 (e.g., a workstation, fleet management system, a computer, a server, a service provider, a technician, an engineer, etc.), and/or another vehicle 72.

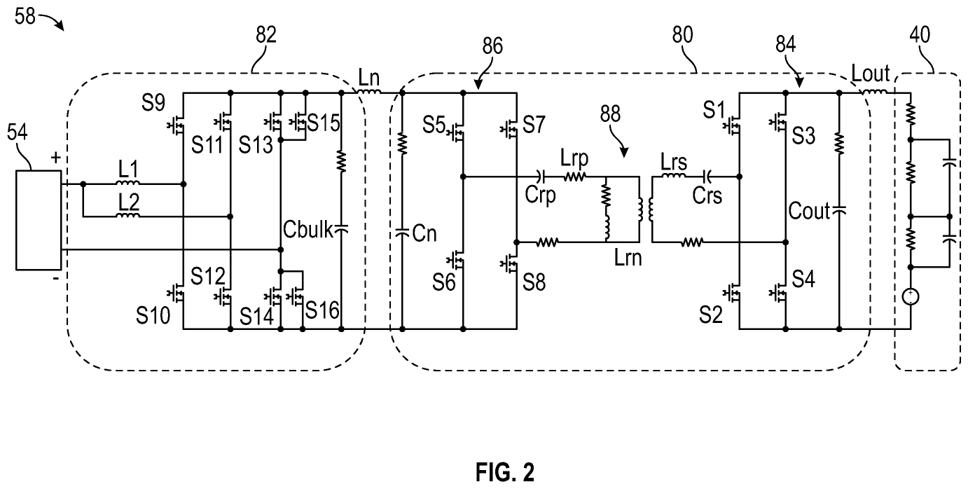

FIG. 2 depicts an example of the conversion device 58. In this example, the conversion device 58 is a bi-directional charger that includes switching stages for converting between AC and DC current and controlling voltage. A DC-DC conversion circuit 80 is configured to step up or step down voltage, and an AC/DC conversion circuit 82 is configured to convert current from AC to DC, or DC to AC. The conversion device 58 can transmit power in both directions and can thus be used for both charging and discharging.

In an embodiment, the DC-DC conversion circuit 80 is an isolated CLLC converter that includes a full bridge circuit 84 including switches S1, S2, S3 and S4, and a full bridge circuit 86 including switches S5, S6, S7 and S8. A LLC resonant tank or circuit is formed by a transformer 88, capacitors Cᵣₛ and Cᵣₚ, and inductors Lᵣₚ, Lᵣₛ and Lᵣₙ.

The AC/DC conversion circuit 82, in an embodiment, is a power factor correction (PFC) converter that combines rectification and power conversion. In this embodiment, the circuit 82 includes inductors L1 and L2 connected to high frequency legs, and a bulk capacitor C_{bulk}. A first high frequency (HF) leg includes switches S9 and S10, and a second HF leg includes switches S11 and S12. A low frequency leg includes switches S13, S14, S15 and S16.

When the vehicle 10 is connected to an external energy storage system, such as another vehicle's battery system, the circuit 84 converts DC current from the battery system 40 to AC (DC-AC stage). The resonant circuit causes a change in voltage, and the circuit 86 converts AC current to DC (AC-DC stage). The circuit 82 converts the DC current to AC current (DC-AC stage).

Power can flow through the conversion device 58 in the forward or reverse direction. For example, when the charge port 54 is connected to another vehicle, high voltage DC current is input to the circuit 84, which converts the DC current to AC and filters current ripple. The circuit 86 and resonant circuit adjust voltage and convert the AC current to DC current, which is provided to the circuit 82 for conversion and filtering.

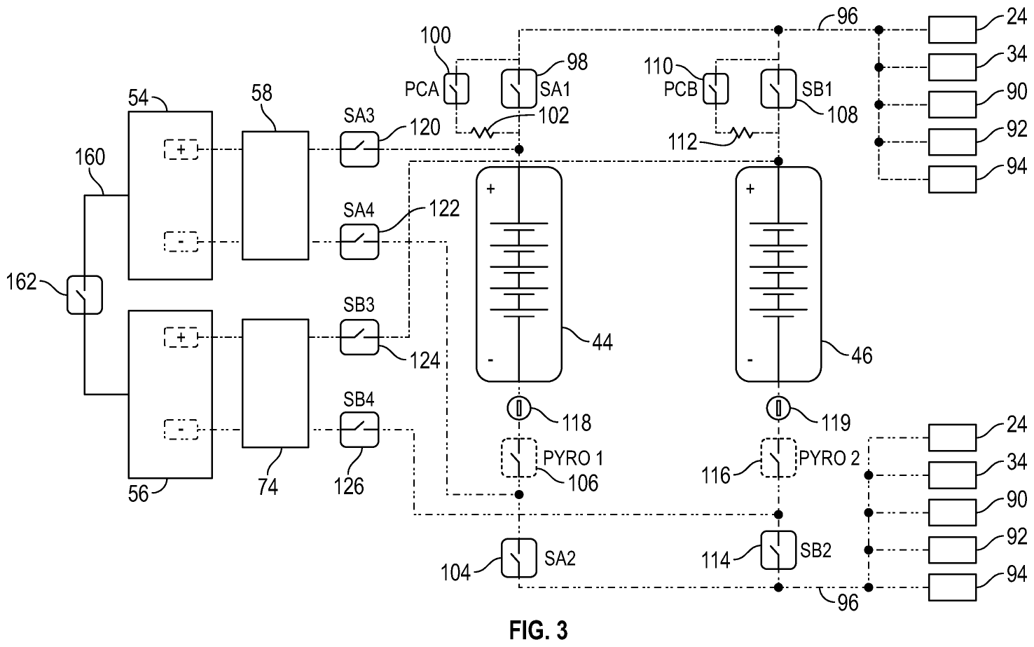

FIG. 3 is a circuit diagram that depicts aspects of an example of the battery system 40 and the charging system. In this example, the conversion device 58 is a bi-directional charger. The charging system may also include a second conversion device 74, which may be uni-directional or bi-directional. For DC fast charging, or supplying DC power to an external system, one of the conversion devices may be bypassed via suitable switches, or one of the conversion devices may be excluded entirely.

In this example, the battery packs 44 and 46 are high voltage (HV) packs, each having a voltage rating of 800 Volts (V), and therefore can hold a voltage of 800 V when fully charged. Embodiments are not so limited, as the vehicle 10 can have any number of battery packs having any suitable voltage rating. For example, the battery packs each have a 400 V rating, and a switch such as the battery switching device 52 may be included for variable voltage (e.g., the battery packs can be connected in parallel to provide 400 V power, or connected in series to provide 800 V power).

The battery packs 44 and 46 are connected in parallel with each other and connected to other vehicle systems, including the propulsion system 16 and various electrical loads. The loads include the inverters 24 and 34, an air conditioning electric compressor (ACEC) 90, an integrated power electronics module (IPEO) 92, and a heater 94.

The battery pack 44 is connected to a positive side of a HV bus 96 by a first main switch 98 (SA1) and a pre-charge device including a first pre-charge switch 100 (PCA) and a first pre-charge resistor 102. The battery pack 44 is connected to a negative side of the HV bus 96 by a first return switch 104 (SA2) and a first pyro-fuse 106 (Pyro 1).

The battery pack 46 is connected to the positive side of the HV bus 96 by a second main switch 108 (SB1) and a pre-charge device including a second pre-charge switch 110 (PCB) and a second pre-charge resistor 112. The battery pack 46 is connected to the negative side of the HV bus 96 by a second return switch 114 (SB2) and a second pyro-fuse 116 (Pyro 2). Current sensors 118 and 119 may be included between the battery packs and the negative side of the HV bus 96.

In general operation (e.g., during propulsion), the first main switch 98 (SA1) is closed and the first pre-charge switch 100 (PCA) is open, allowing current to bypass the first pre-charge resistor 102. The second main switch 108 (SB1) is closed and the second pre-charge switch 110 (PCB) is open, allowing current to bypass the second pre-charge resistor 112.

During a pre-charging operation, the first main switch 98 (SA1) is open and the first pre-charge switch 100 (PCA) is closed, causing current to flow through the first pre-charge resistor 102, thereby charging capacitances in the battery system and/or loads. In addition, or alternatively, the second main switch 108 (SB1) is open and the second pre-charge switch 110 (PCB) is closed, causing current to flow through the second pre-charge resistor 112.

In the charging system, the charge port 54 is selectively connected to the battery pack 44 by a switch 120 (SA3) connected to a positive terminal of the battery pack 44, and a switch 122 (SA4) at a negative terminal of the battery pack 44. The charge port 56 is selectively connected to the battery pack 46 by a switch 124 (SB3) connected to a positive terminal of the battery pack 46, and a switch 126 (DB4) connected a negative terminal of the battery pack 46.

A controller, such as the controller 59 or a BMS controller, operates the various switches to transition the vehicle between various operating modes and charging modes. For example, the battery system 40 can be controlled to charge the first battery pack 44 and the second battery pack 46 either individually or together. Both battery packs can be connected in parallel and charged from either one of the charge ports or from both charge ports simultaneously.

During a parallel charging operation in which a single charge port is used, only one of the battery packs 44 and 46 is connected to its charge port for charging while both battery packs 44 and 46 are connected in parallel to other loads. In an individual charging operation, both battery packs 44 and 46 are connected to their respective charge ports, while only one battery pack is connected to another load or loads.

The system of FIG. 2 allows for the loads to be supported during a charging operation. The loads are protected from an inrush of current by the pre-charge devices. The battery packs 44 and 46 can be charged either simultaneously in parallel, or individually via each charge port. Thus, in some instances, a single charge port can be utilized while another charge port is not used.

In addition, the controller can control the various switches (and the conversion devices) so that the charge ports 54 and 56 are simultaneously used to receive power to charge the battery system 40 (i.e., the battery pack 44 and/or the battery pack 46), and to supply power to another system. For example, the charge port 56 can be plugged into a charging station and receive DCFC current to charge the battery pack 46, and the charge port 54 can be connected to another vehicle (recipient vehicle) so that the battery pack 44 charges the recipient vehicle battery.

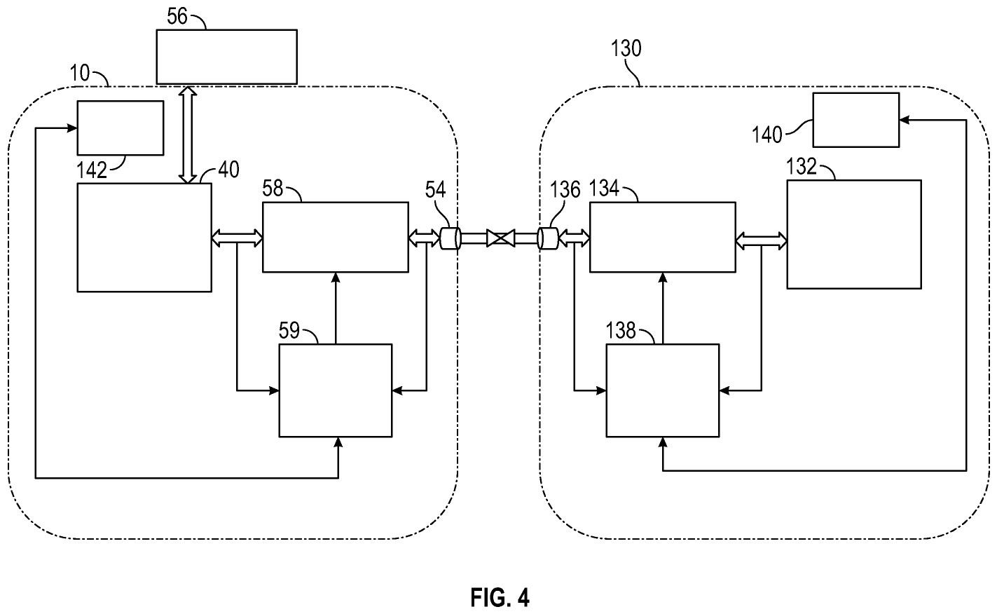

FIG. 4 depicts an embodiment of the charging system, and an example of a use of the charging system to perform dual port or multi-port charging. In this example, the vehicle 10 is a donor vehicle that supplies power to another vehicle 130 (recipient vehicle). The recipient vehicle 130 includes a battery system 132 and a charging system having a conversion device 134 (e.g., a uni-directional or bi-directional charger) and a charge port 136. A controller 138 controls functions of the charging system and the conversion device 134. The controller 138 may communicate with the vehicle 10 through a cable connection or wirelessly to share information such as the recipient vehicle's charging parameters, state of charge (SOC) of the battery system 132, status information, pricing information, and others.

Charging information may also be presented to a user via a display 140 or other interface. For example, the controller 138 can present information such as charging status, SOC, energy use, pricing information and others. The user can use this information to monitor charging and control when charging ends. Likewise, charging information can be presented to a user of the donor vehicle 10 through a display 142 or other interface.

In this embodiment, one charge port functions as a primary port for charging the battery system 40, and another charger functions as a secondary port to allow the vehicle 10 to simultaneously supply power to another system for V2V or V2X charging. For example, the charge port 56 is the primary charge port, which receives AC current from a charging station (or DC current from a DCFC station) and charges the battery system. The charge port 54 is the secondary charge port, which supplied DC current from the battery system 40 to the recipient vehicle 130.

The charging system can be used to simultaneously supply charge to a storage system while receiving charge from any power source. For example, the vehicle 10 can be connected to a donor vehicle to charge the battery system 40, and also connected to a recipient vehicle to charge the recipient vehicle.

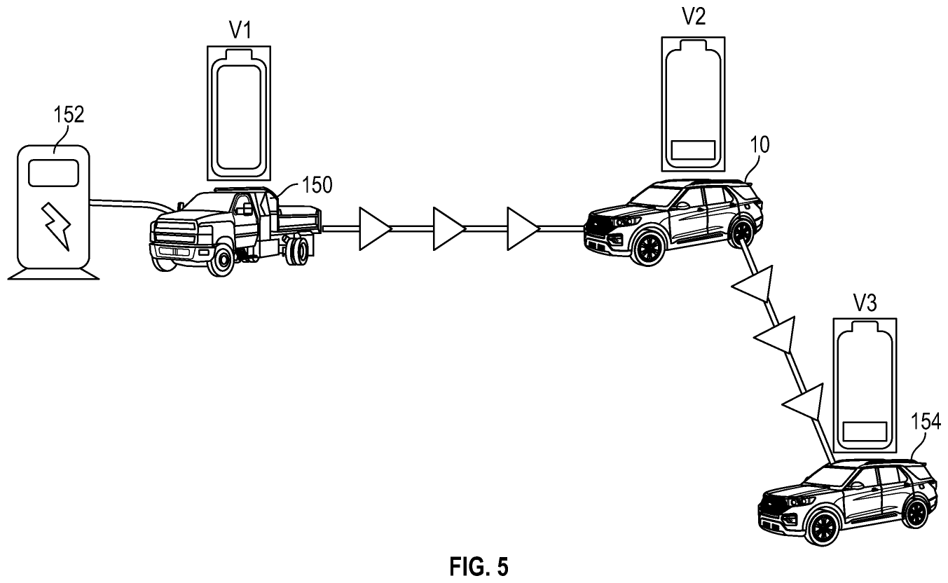

FIG. 5 depicts an example in which multiple vehicles have a dual port charging system, allowing a plurality of vehicles to be daisy-chained. In this example, a donor vehicle 150 includes a dual port charging system, in which one port is connected to a charging station 152 and another port is connected to the vehicle 10. The battery systems of the vehicles 150 and 10 are thus connected in parallel, and charge is provided to both battery systems.

If the vehicle 10 also includes a dual port charging system, the vehicle 10 can be connected to another vehicle 154 by a charging cable. The battery systems of all three vehicle can this be connected in parallel, allowing all of the vehicles to be charged simultaneously. The controller 59 and controllers in the vehicles 150 and 154 can communicate to share charging information, including the SOC of each vehicle, the voltage of each vehicle (V1, V2 and V3), current and other information.

In some instances, it may be desirable to bypass a battery system of a connected vehicle (e.g., if the vehicle is already sufficiently charged). For example, the battery system 40 of the vehicle 10 can be bypassed during charging so that power flows directly from the vehicle 150 to the vehicle 154.

Referring again to FIG. 3, the charging system may be configured to allow the battery system 40 to be bypassed. For example, a bypass conductor or bypass lead 160 connects a bypass switch 162 that can be closed by the controller 59 to bypass the battery system 40 by transferring current directly between the charge ports 54 and 56. When being bypassed, the switches 120, 122, 124 and 126 may also be opened.

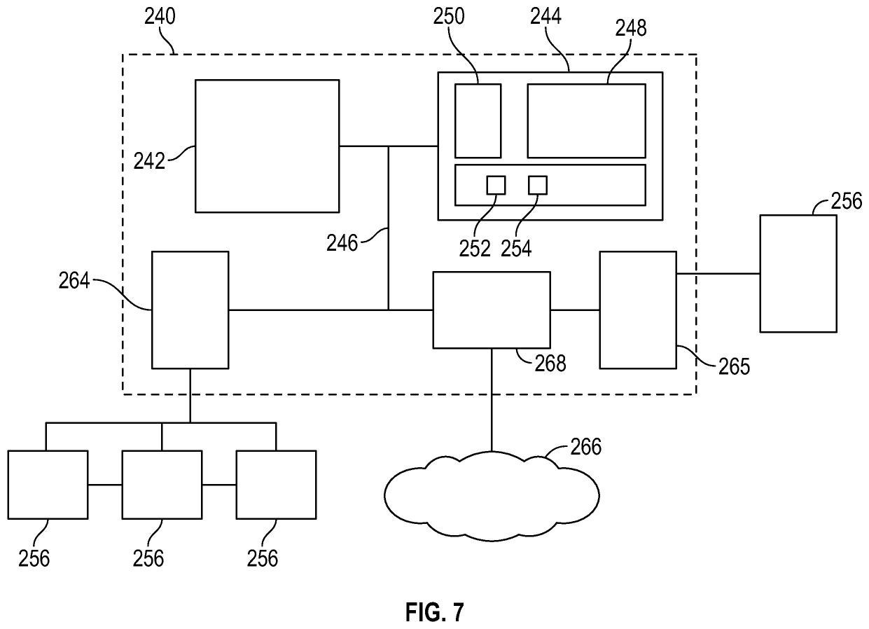

FIG. 7 illustrates embodiments of a method 200 of transferring charge from a battery system of a vehicle (a first vehicle or donor vehicle) to an energy storage device such as a battery system of another vehicle (a second vehicle or recipient vehicle). The method 200 may include simultaneously or concurrently charging the battery system and the energy storage system using a multi-port charging system.

Aspects of the method 200 may be performed by a processor or processors disposed in a vehicle, such as the controller 59 and/or the controller 138. In an embodiment, the method 200 is performed in conjunction with a processing device in the recipient vehicle (or processing device connected to a recipient energy storage system). For example, aspects of the method 200 are performed by the controller 59 in conjunction with the recipient vehicle controller 138 (and in conjunction with one or more other vehicle controllers if additional vehicles are connected). It is noted the method 200 is not so limited and may be performed by any suitable processing device or system, or combination of processing devices.

The method 200 includes a number of steps or stages represented by blocks 201-206. The method 200 is not limited to the number or order of steps therein, as some steps represented by blocks 201-206 may be performed in a different order than that described below, or fewer than all of the steps may be performed.

The method 200 is described in conjunction with the vehicle 10 and the systems of FIGS. 2 and 3 for illustration purposes. The method 200 is not so limited and can be used with any suitable vehicle battery system and any suitable charging system having dual or multi-port charging capability. In addition, the method 200 is described as being performed to charge the battery system 132 of the recipient vehicle 130; however, the method may be performed in conjunction with any vehicle having a battery system and suitable charge port, or any suitable external energy storage system.

At block 201, a first charging process is initiated to charge the battery system 40. The first charging process many be initiated by putting the vehicle 10 into a charging mode and connecting the charge port 56 to a power source, such as an electrical grid or a charging station. The controller 59 initiates charging the battery system 40, or only charging the battery pack 46.

For example, the first charging process is performed to charge the battery pack 46. The controller 59 can optionally pre-charge the battery pack 46 by opening the second main switch 108 and closing the second pre-charge switch 110 so that current flows through the resistor 112.

The battery pack 46 is electrically connected to the power source by opening the main switch 108, and closing the second return switch 116 if open. The switches 124 and 126 are closed and current from the power source is supplied to the battery pack through the charge port 56.

The conversion device 74 may be used to control charging parameters, such as voltage, if there is a difference in voltage between the power source and the battery pack 46. In addition, if the power source is an AC source, the conversion device 74 is used to convert AC to DC current and adjust voltage if desired. If the power source is a DCFC station, some or all of the switching stages of the conversion device 74 may be bypassed so that DC current flows directly to the battery pack 46.

At block 202, the recipient vehicle 130 is connected to the vehicle 10. For example, the recipient controller 138 causes the vehicle 130 to enter a charging mode, and the controller 138 communicates with the controller 59 to send charging parameter information. From this communication, the controller 59 determines various charging parameters such as the recipient vehicle's nominal battery voltage, maximum allowable charge current and desired charge energy. This information can be received via user input, a wireless signal from the recipient vehicle, a signal transmitted over the charging cable, or otherwise.

In an embodiment, the vehicle 10 and/or the controller 59 can communicate with the recipient vehicle 130 over a charging cable. In addition, or alternatively, the vehicles 10 and 130 can communicate wirelessly.

At block 203, a second charging operation commences, and the recipient vehicle battery system 132 receives charge from the battery system 40 through the bi-directional conversion device 58, the charge ports 54 and 136, and the conversion device 134. Charge may be transferred from one or more battery packs in the vehicle 10.

For example, to commence the second charging operation, the controller 59 opens the first main switch 98 and the pre-charge switch 100 if open, and closes the switches 120 and 122 to electrically couple to the battery pack 44 to the conversion service 58 and the charge port 54. The controller 59 controls the conversion device to adjust voltage as needed, or bypasses the conversion device 58 if the voltage of the battery pack 44 and the battery system 132 are the same or similar.

It is noted that the second charging process can be commenced and performed at any time relative to the first charging process. In an embodiment, the second charging process is performed as the battery system 40 is being charged. For example, as the first charging process is being performed and the battery pack 46 is being charged, the battery pack 44 is simultaneously supplying charge to the battery system 132.

At block 204, the controller 59 and/or the controller 138 monitor the second charging operation to determine whether the battery system 138 has been sufficiently charged, or otherwise determine whether the second charging operation should be ended. For example, the controller 138 continuously or periodically receives charging information such as SOC, current, temperature and voltage. The controller 138 may send this information to the controller 59.

The controller 138 and/or the controller 59 may end the second charging operation when the SOC of the battery system 132 reaches a desired level. The desired level may be determined relative to a maximum SOC of the battery system 132.

The second operation may be ended by a user, such as a user of the vehicle 10 or a user of the vehicle 130. A user can monitor charging via the display 140 or 142, and provide an input to end the process. For example, a user (or the controller 59) may end the process by monitoring pricing information and providing the input when the charging price reaches a desired amount.

At block 205, upon determining that the second charging process should end, the controllers 59 and 138 perform appropriate functions to electrically decouple the vehicles. For example, the controller 59 opens the switches 120 and 122 to disconnect the battery pack 44 from the charge port 54. The controller 138 similarly disconnects the battery system 132 from the charge port 136. At this point, the charge ports 54 and 136 are disconnected by removing the charging cable.

At block 206, controller 59 monitors the first charging process, and disconnects the battery pack 46 from the charge port 56 by opening switches 124 and 126. The charge port 56 is then disconnected from the power source.

In some instances, there may be more than one vehicle connected to the donor vehicle during the first charging operation, such as in a daisy chain configuration shown in FIG. 5. In such instances, one or more controllers monitor the voltage and SOC of each connected battery system as the battery systems are being charged.

FIG. 7 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 252 may be included for performing functions related to acquiring signals and data, and a module 254 may be included to perform functions related to control of charging as discussed herein. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A charging system of a vehicle, comprising:
a first charge port selectively connectable to a battery system of the vehicle, the first charge port configured to receive electrical power from a power source to charge the battery system;
a second charge port selectively connectable to the battery system of the vehicle, the second charge port connected to a bi-directional charger; and
a controller configured to:
connect the battery system to the first charge port and control a first charging operation to charge the battery system;
connect the battery system to the second charge port; and
control a second charging operation to supply electrical power to charge an external energy storage system.

2. The charging system of claim 1, wherein the external energy storage system is a recipient vehicle connected to the second charge port by a charging cable.

3. The charging system of claim 2, wherein the power source is selected from a charging station, an electrical grid and another vehicle.

4. The charging system of claim 1, wherein the second charging operation is performed simultaneously with the first charging operation.

5. The charging system of claim 1, wherein the battery system includes a first battery pack and a second battery pack connected in parallel to a vehicle propulsion system, the first charge port is selectively connectable to the first battery pack, and the second charge port is selectively connectable to the second battery pack.

6. The charging system of claim 5, wherein the controller is configured to control the first charge port to charge the first battery pack with the electrical power from the power source, and control the second charge port and the bi-directional charger to charge the external energy storage system.

7. The charging system of claim 1, wherein the controller is configured to communicate with a recipient controller of the external energy storage system, the recipient controller configured to provide charging parameters for the second charging operation.

8. The charging system of claim 7, wherein the controller is configured to acquire pricing information related to the power source, and perform at least one of: monitoring the second charging operation, controlling the second charging operation based on the pricing information, and providing the pricing information to a recipient controller of the external energy storage system.

9. The charging system of claim 1, wherein the power source is a donor battery system of a donor vehicle, the external energy storage system is a recipient vehicle, and the controller is configured to perform at least one of:
controlling the first charge port to charge the battery system and controlling the second charge port to simultaneously charge the recipient vehicle; and
controlling the first charge port to receive a charging current from the donor battery system, and controlling one or more switches connected to the battery system to bypass the battery system and transfer the charging current to the recipient vehicle.

10. A method of transferring charge, comprising:
connecting a power source to a first charge port, and electrically coupling the first charge port to a battery system of the vehicle, the first charge port configured to receive electrical power from the power source to charge a battery system;
connecting an external energy storage system to a second charge port, and electrically coupling the second charge port to the battery system, the second charge port connected to a bi-directional charger;
performing a first charging operation to charge the battery system; and
performing a second charging operation to supply electrical power to charge the external energy storage system.

11. The method of claim 10, wherein the external energy storage system is a recipient vehicle connected to the second charge port by a charging cable, and the power source is selected from a charging station, an electrical grid and another vehicle.

12. The method of claim 10, wherein the second charging operation is performed simultaneously with the first charging operation.

13. The method of claim 10, wherein the battery system includes a first battery pack and a second battery pack connected in parallel to a vehicle propulsion system, the first charge port is selectively connectable to the first battery pack, and the second charge port is selectively connectable to the second battery pack.

14. The method of claim 13, wherein performing the first charging operation includes controlling the first charge port to charge the first battery pack with the electrical power from the power source, and performing the second charging operation includes controlling the second charge port and the bi-directional charger to charge the external energy storage system.

15. The method of claim 10, further comprising communicating with a recipient controller of the external energy storage system to determine charging parameters for the second charging operation.

16. The method of claim 15, wherein the communicating includes acquiring pricing information related to the power source, and performing at least one of: monitoring the second charging operation, controlling the second charging operation based on the pricing information, and providing the pricing information to a recipient controller of the external energy storage system.

17. A vehicle system, comprising:
a battery system; and
a charging system connected to the battery system, the charging system including a controller configured to perform a method comprising:
connecting a power source to a first charge port, and electrically coupling the first charge port to the battery system, the first charge port configured to receive electrical power from the power source to charge the battery system;
connecting an external energy storage system to a second charge port, and electrically coupling the second charge port to the battery system, the second charge port connected to a bi-directional charger;
performing a first charging operation to charge the battery system; and
performing a second charging operation to supply electrical power to charge the external energy storage system.

18. The vehicle system of claim 17, wherein the second charging operation is performed simultaneously with the first charging operation.

19. The vehicle system of claim 17, wherein the battery system includes a first battery pack and a second battery pack connected in parallel to a vehicle propulsion system, the first charge port is selectively connectable to the first battery pack, and the second charge port is selectively connectable to the second battery pack.

20. The vehicle system of claim 19, wherein the controller is configured to control the first charge port to charge the first battery pack with the electrical power from the power source, and control the second charge port and the bi-directional charger to charge the external energy storage system.
